(19) United States
(12) Patent Application Publication
(10) Pub. No.: US 2024/0136114 A1
(43) Pub. Date: Apr. 25, 2024

(54) COIL COMPONENT

(71) Applicant: SAMSUNG ELECTRO-MECHANICS CO., LTD., Suwon-si (KR)

(72) Inventors: Eo Jin CHOI, Suwon-si (KR); Byeong Cheol MOON, Suwon-si (KR)

(73) Assignee: SAMSUNG ELECTRO-MECHANICS CO., LTD., Suwon-si (KR)

(21) Appl. No.: 18/371,161

(22) Filed: Sep. 20, 2023

(30) Foreign Application Priority Data
Oct. 19, 2022 (KR) 10-2022-0135931

(51) Int. Cl. H01F 27/29; H01F 17/00; H01F 17/04

(52) U.S. Cl. CPC H01F 27/292; H01F 17/0013; H01F 17/045

(57) ABSTRACT

A coil component includes: a body having a first surface and a second surface opposing each other in a first direction; a support member disposed in the body; a coil disposed on the support member, and including a coil pattern having at least one turn and a lead portion extending from the coil pattern to at least one of the first surface and second surface of the body; and external electrodes disposed on the body and respectively connected to the lead portions, wherein a partial region of an outermost turn of the coil pattern has a line width smaller than that of the other region, and at least one of the lead portions is biased to one side based on a center line passing through a center of the coil pattern while being parallel to the first direction.

### CROSS-REFERENCE TO RELATED APPLICATION(S)

This application claims benefit of priority to Korean Patent Application No. 10-2022-0135931 filed on Oct. 20, 2022 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in an electronic device together with a resistor and a capacitor.

As electronic devices gradually become more sophisticated and miniaturized, the number of electronic components used in electronic devices is also increased and their sizes are miniaturized.

In order to implement a coil component with high capacity and high efficiency even in a small package, there is a demand for a coil structure in which a central core of a coil has a larger area.

### SUMMARY

An aspect of the present disclosure may provide a coil component with an improved saturation current (Isat) characteristic in which a central core of a coil has a larger area to thus facilitate a flow of magnetic flux.

Another aspect of the present disclosure may provide a coil component suppressing a side effect which is caused by the condition that direct current (DC) resistance R_{dc} is increased due to a reduced cross-sectional area of a lead portion.

According to some embodiments of the present disclosure, a coil component may include: a body having a first surface and a second surface opposing each other in a first direction, and a third surface and a fourth surface opposing each other in a second direction, perpendicular to the first direction; a support member disposed in the body; a coil disposed on the support member, and including a coil pattern having at least one turn and a lead portion extending from the coil pattern to at least one of the first surface and second surface of the body; and an external electrode disposed on the body and connected to the lead portion, wherein a partial region of an outermost turn of the coil pattern has a line width smaller than that of the other region, and at least one of the lead portions is off-centered and disposed on one side of the body based on a center line passing through a center of the coil pattern while being parallel to the first direction.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to a first exemplary embodiment of the present disclosure;

FIG. 2 is a partially enlarged view of FIG. 1, and illustrates an L-W cross-section of the coil component;

FIG. 3 is a view illustrating a cross-section taken along line I-I′ of FIG. 1;

FIG. 4 is a view illustrating a cross-section taken along line II-II′ of FIG. 1;

FIG. 5 is a view illustrating a cross-section taken along line of FIG. 1;

FIG. 6 is a partially enlarged view of a coil component according to a second exemplary embodiment of the present disclosure, illustrates an L-W cross-section of the coil component, and is a view corresponding to FIG. 2;

FIG. 7 is a view schematically illustrating an L-W cross-section of a coil component according to a third exemplary embodiment of the present disclosure, and is a view corresponding to FIG. 2; and

FIG. 8 is a view schematically illustrating an L-W cross-section of a coil component according to a fourth exemplary embodiment of the present disclosure, and is a view corresponding to FIG. 2.

### DETAILED DESCRIPTION

Hereinafter, exemplary embodiments of the present disclosure will now be described in detail with reference to the accompanying drawings.

In the drawings, an L direction refers to a first direction or length direction, a W direction refers to a second direction or width direction, and a T direction refers to a third direction or thickness direction.

Hereinafter, a coil component according to exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and an overlapping description thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter, or the like.

### First Exemplary Embodiment

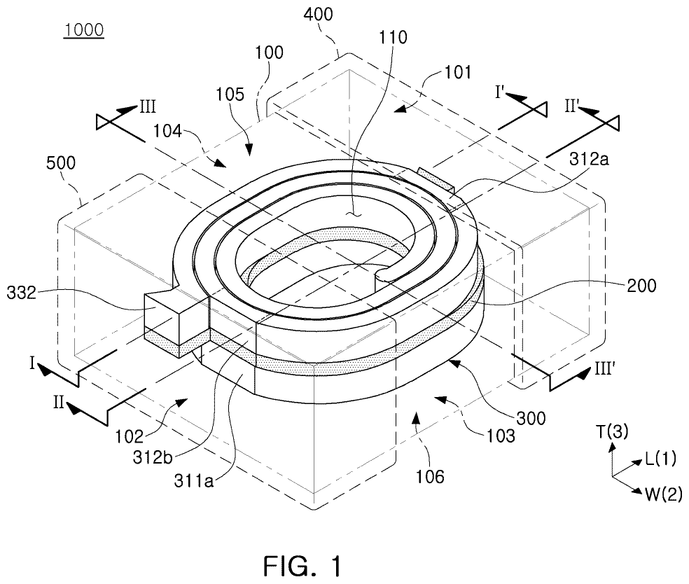

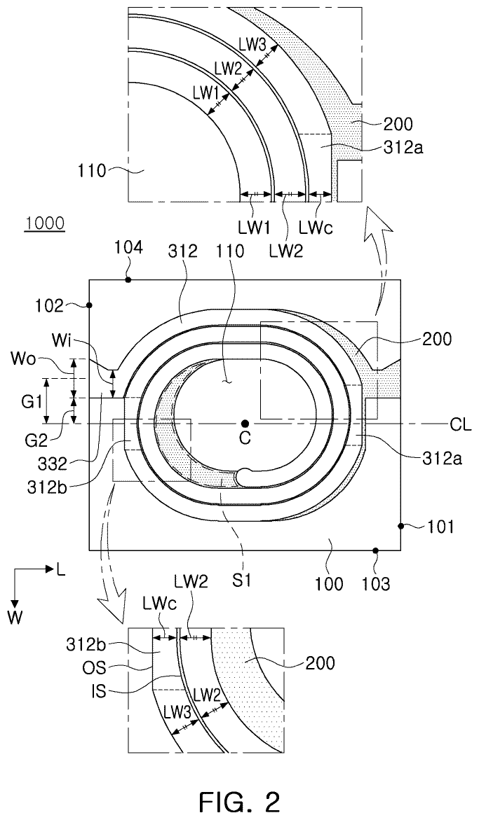

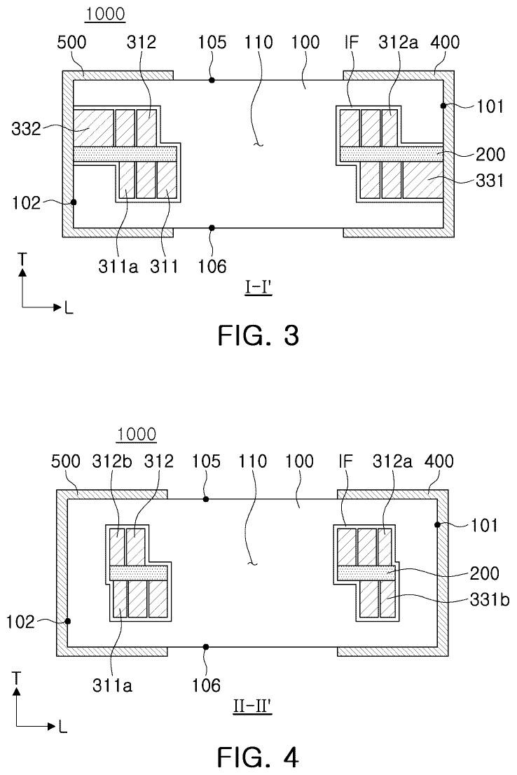

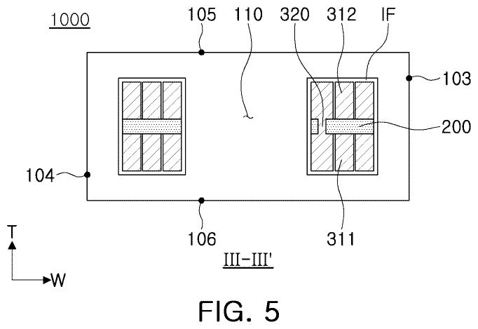

FIG. 1 is a perspective view schematically illustrating a coil component 1000 according to a first exemplary embodiment of the present disclosure; FIG. 2 is a partially enlarged view of FIG. 1, and illustrates an L-W cross-section of the coil component; FIG. 3 is a view illustrating a cross-section taken along line I-I′ of FIG. 1; FIG. 4 is a view illustrating a cross-section taken along line II-II′ of FIG. 1; and FIG. 5 is a view illustrating a cross-section taken along line III-III′ of FIG. 1.

Meanwhile, the drawings omit an insulating layer disposed on a body 100 that is applied to this exemplary embodiment to more clearly show coupling between components.

Referring to FIGS. 1 through 5, the coil component 1000 according to a first exemplary embodiment of the present disclosure may include the body 100, a support member 200, a coil 300, and external electrodes 400 and 500.

The body 100 may form an exterior of the coil component 1000 according to this exemplary embodiment, and may embed the support member 200 and the coil 300.

The body 100 may generally have a hexahedral shape.

The body 100 may include a first surface 101 and a second surface 102 opposing each other in the length (L) direction or first direction, a third surface 103 and a fourth surface 104 opposing each other in the width (W) direction or second direction, and a fifth surface 105 and a sixth surface 106 opposing each other in the thickness (T) direction or third direction. Each of the first to fourth surfaces 101, 102, 103, and 104 of the body 100 may correspond to a wall surface of the body 100 that connects the fifth and sixth surfaces 105 and 106 of the body 100 to each other.

For example, the body 100 may be formed for the coil component 1000 according to this exemplary embodiment including the external electrodes 400 and 500 described below to have: a length of 2.5 mm, a width of 2.0 mm, and a thickness of 1.0 mm; a length of 2.0 mm, a width of 1.2 mm, and a thickness of 0.65 mm; a length of 1.6 mm, a width of 0.8 mm, and a thickness of 0.8 mm; a length of 1.0 mm, a width of 0.5 mm, and a thickness of 0.8 mm; or a length of 0.8 mm, a width of 0.4 mm, and a thickness of 0.65 mm. However, the present disclosure is not limited thereto. Meanwhile, the above exemplary dimensions for the length, width, and thickness of the coil component 1000 may be dimensions that do not reflect process errors, and a range of the dimensions recognized to include the process errors may thus fall within that of the above-described exemplary dimensions.

The above length of the coil component 1000 may indicate the maximum value of respective dimensions of a plurality of line segments spaced apart from each other in the thickness (T) direction, and connecting two outermost boundary lines opposing each other in the length (L) direction of the coil component 1000 shown in the following image to be parallel to the length (L) direction, based on the optical microscope image or scanning electron microscope (SEM) image of a cross-section of the coil component 1000 in a length (L)-thickness (T) direction that is taken from its center in the width (W) direction. Alternatively, the length of the coil component 1000 may indicate the minimum value of the respective dimensions of the plurality of line segments described above. Alternatively, the length of the coil component 1000 may indicate an arithmetic average value of at least three of the respective dimensions of the plurality of line segments described above. Here, the plurality of line segments parallel to the length (L) direction may be equally spaced from each other in the thickness (T) direction, and the scope of the present disclosure is not limited thereto.

The above thickness of the coil component 1000 may indicate the maximum value of respective dimensions of a plurality of line segments spaced apart from each other in the length (L) direction, and connecting two outermost boundary lines opposing each other in the thickness (T) direction of the coil component 1000 shown in the following image to be parallel to the thickness (T) direction, based on the optical microscope image or scanning electron microscope (SEM) image of the cross-section of the coil component 1000 in the length (L)-thickness (T) direction that is taken from its center in the width (W) direction. Alternatively, the thickness of the coil component 1000 may indicate the minimum value of the respective dimensions of the plurality of line segments described above. Alternatively, the thickness of the coil component 1000 may indicate an arithmetic average value of at least three of the respective dimensions of the plurality of line segments described above. Here, the plurality of line segments parallel to the thickness (T) direction may be equally spaced from each other in the length (L) direction, and the scope of the present disclosure is not limited thereto.

The above width of the coil component 1000 may indicate the maximum value of respective dimensions of a plurality of line segments spaced apart from each other in the length (L) direction, and connecting two outermost boundary lines opposing each other in the width (W) direction of the coil component 1000 shown in the following image to be parallel to the width (W) direction, based on the optical microscope image or scanning electron microscope (SEM) image of a cross-section of the coil component 1000 in a length (L)-width (W) direction that is taken from its center in the thickness (T) direction. Alternatively, the width of the coil component 1000 may indicate the minimum value of the respective dimensions of the plurality of line segments described above. Alternatively, the width of the coil component 1000 may indicate an arithmetic average value of at least three of the respective dimensions of the plurality of line segments described above. Here, the plurality of line segments parallel to the width (W) direction may be equally spaced from each other in the length (L) direction, and the scope of the present disclosure is not limited thereto.

Alternatively, each of the length, width and thickness of the coil component 1000 may be measured using a micrometer measurement method. The micrometer measurement method may be used by setting a zero point with a micrometer using a repeatability and reproducibility (Gage R&R), inserting the coil component 1000 according to this exemplary embodiment between tips of the micrometer, and turning a measurement lever of the micrometer. Meanwhile, when measuring the length of the coil component 1000 by using the micrometer measurement method, the length of the coil component 1000 may indicate a value measured once or an arithmetic average of values measured several times. This method may be equally applied to measure the width or thickness of the coil component 1000.

The body 100 may include a magnetic material and a resin. In detail, the body 100 may be formed by laminating one or more magnetic composite sheets in which the magnetic material is dispersed in the resin. However, the body 100 may also have a structure other than the structure in which the magnetic material is dispersed in the resin. For example, the body 100 may be made of a magnetic material such as ferrite or a non-magnetic material.

The magnetic material may include the ferrite or metal magnetic powders.

The ferrite may include, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite, a hexagonal type ferrite such as Ba—Zn-based ferrite, Ba—Mg-based ferrite, Ba—Ni-based ferrite, Ba—Co-based ferrite or Ba—Ni—Co-based ferrite, a garnet type ferrite such as Y-based ferrite, and Li-based ferrite.

The metal magnetic powders may include at least one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powders may be at least one or more of pure iron powders, Fe—Si-based alloy powders, Fe—Si—Al-based alloy powders, Fe—Ni-based alloy powders, Fe—Ni—Mo-based alloy powders, Fe—Ni—Mo—Cu-based alloy powders, Fe—Co-based alloy powders, Fe—Ni—Co-based alloy powders, Fe—Cr-based alloy powders, Fe—Cr—Si-based alloy powders, Fe—Si—Cu—Nb-based alloy powders, Fe—Ni—Cr-based alloy powders, and Fe—Cr—Al-based alloy powders.

The metal magnetic powders may be amorphous or crystalline. For example, the metal magnetic powders may include Fe—Si—B—Cr-based amorphous alloy powders, and are not necessarily limited thereto.

The ferrite and the metal magnetic powders may respectively have average diameters of about 0.1 μm to 30 μm, but the present disclosure is not limited thereto.

The body 100 may include two or more types of magnetic materials dispersed in the resin. Here, different types of magnetic materials may indicate that the magnetic materials dispersed in the resin are distinguished from each other by any one of an average diameter, a composition, crystallinity, and a shape.

The resin may include an epoxy, a polyimide, a liquid crystal polymer (LCP), or the like, or mixtures thereof, but the present disclosure is not limited thereto.

The body 100 may include a core 110 passing through the support member 200 and the coil 300, described below. The core 110 may be formed by filling a through hole of the support member 200 with the magnetic composite sheet, but the present disclosure is not limited thereto.

The support member 200 may be disposed in the body 100. The support member 200 is a component supporting the coil 300 described below. Meanwhile, the support member 200 may be excluded in some exemplary embodiments, such as a case where the coil 300 correspond to a wound coil or has a coreless structure.

The support member 200 may be made of an insulating material including thermosetting resin such as an epoxy resin, a thermoplastic insulating resin such as polyimide, or a photosensitive insulating resin, or may be made of an insulating material having a reinforcement material such as a glass fiber or an inorganic filler impregnated in the insulating resin. For example, the support member 200 may be made of a material such as prepreg, an Ajinomoto Build-up Film (ABF), FR-4, bismaleimide triazine (BT) resin, a photo imagable dielectric (PID) or a copper clad laminate (CCL), but the present disclosure is not limited thereto.

The inorganic filler may use at least one or more materials selected from the group consisting of silica (or silicon dioxide, SiO₂), alumina (or aluminum oxide, Al₂O₃), silicon carbide (SiC), barium sulfate (BaSO₄), talc, clay, mica powders, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

Here, when made of the insulating material including the reinforcing material, the support member 200 may have more excellent rigidity. The support member 200 may be made of the insulating material including no glass fiber. In this case, an entire thickness of the support member 200 and the coil 300 (indicating a sum of the respective dimensions of the coil 300 and the support member 200 in the third or T direction of FIG. 1) may be thinned, which is advantageous in reducing the thickness of the component. The support member 200 may be made of the insulating material including the photosensitive insulating resin. In this case, the number of processes for forming the coil 300 may be reduced, which is advantageous in reducing a production cost, and a fine via 320 may also be formed. For example, the support member 200 may have a thickness of 10 μm or more and 50 μm or less, but the present disclosure is not limited thereto.

The coil 300 may be disposed on the support member 200. The coil 300 may be embedded in the body 100 to express a characteristic of the coil component. For example, when the coil component 1000 of this exemplary embodiment is used as the power inductor, the coil 300 may store an electric field as a magnetic field to maintain an output voltage, thereby stabilizing power of the electronic device.

The coil 300 may be disposed on at least one of both surfaces of the support member 200 that oppose each other, and have at least one turn. In this exemplary embodiment, the coil 300 may include first and second coil patterns 311 and 312, the via 320, and first and second lead portions 331 and 332.

Referring to FIGS. 1 through 5, the first coil pattern 311 and the second coil pattern 312 may respectively be disposed on both the surfaces of the support member 200 that oppose each other, and have a shape of a planar spiral in which at least one turn is formed around the core 110 of the body 100. For example, the first coil pattern 311 may be disposed on a lower surface of the support member 200 based on directions shown in FIG. 1, and have at least one turn wound around the core 110. The second coil pattern 312 may be disposed on an upper surface of the support member 200, and have at least one turn wound around the core 110. Each of the first and second coils patterns 311 and 312 may have the outermost turn whose end is connected to each of the first and second lead portions 331 and 332 extending to the first surface 101 and the second surface 102 of the body 100, respectively.

Referring to FIGS. 1, 2, and 4, a partial region of the outermost turn of the coil pattern 311 or 312 may have a line width in the second direction smaller than a line width in the second direction of the adjacent turn of the coil pattern 311 or 312. The reason why the partial region of the outermost turn has the smaller line width as mentioned above is to improve an inductance characteristic of the coil component by making an area of the central core 110 larger by a volume of the body 100 that is further secured on the outside of the coil 300. This structure may further improve the inductance characteristic when combined with first or second the lead portion 331 or 332 off-centered described below.

Referring to FIGS. 2 and 4, a region of the outermost turn of the second coil pattern 312 that faces the first surface 101 or second surface 102 of the body 100 may have the smaller line width than the other regions. The region of the outermost turn that has the smaller line width than the other regions may be referred to as a cut portion 312a or 312b. In this case, the outermost turn of at least one of the first coil pattern 311 or the second coil pattern 312 may include at least one cut portion 312a or 312b, respectively. In some exemplary embodiments, the first coils pattern 311 may include two cut portions 311a and 311b, and the second coil pattern 312 may include two cut portions 312a and 312b, but the present disclosure is not limited thereto, and the outermost turns of the first coil patterns 311 may include at least one cut portion 311a or 311b, and the outermost turns of the second coil patterns 312 may include at least one cut portion 312a or 312b. For convenience, a boundary line of the cut portion 311a, 311b, 312a, or 312b is marked with dotted lines to be distinguished from its adjacent regions. However, the cut portion may be integrally formed with the adjacent regions as a part of the outermost turn.

Referring to FIG. 2, for example, the cut portion 312a or 312b of the outermost turn of the second coil pattern 312 may have a smaller line width LWc than a line width LW3 of the adjacent region. Here, the line width of the outermost turn may indicate, for example, an arithmetic average value of at least three of respective dimensions of a plurality of line segments spaced apart from each other and connecting respective boundaries of the inner surface IS and outer surface OS of the outermost turn shown in the following image, based on the optical microscope image or scanning electron microscope (SEM) image of a cross-section of the coil pattern 311 or 312 of the coil component 1000 in the length (L)-width (W) direction that is taken from its center in the thickness (T) direction. Here, the plurality of line segments may be equally spaced from each other, and the scope of the present disclosure is not limited thereto.

Referring to FIG. 2, the cut portion 311a, 311b, 312a, or 312b may include the inner surface IS and the outer surface OS opposing each other, and the inner surface IS and the outer surface OS may have curvatures different from each other. In this exemplary embodiment, the outer surface OS of the cut portion 311a, 311b, 312a, or 312b may have the curvature smaller than that of the inner surface IS, and the outer surface OS may be flat. In this case, the curvature of the outer surface OS of the cut portion 311a, 311b, 312a, or 312b may have a value close to zero, but the present disclosure is not limited thereto

Referring to FIG. 2, for example, the cut portion 312a or 312b of the outermost turn of the second coil pattern 312 may have the average line width LWc smaller than an average line width LW1 or LW2 of a turn adjacent thereto. Here, the line width of the outermost turn may indicate, for example, the arithmetic average value of at least three of the respective dimensions of the plurality of line segments spaced apart from each other and connecting the respective boundaries of the inner surface IS and outer surface OS of the outermost turn shown in the following image, based on the optical microscope image or scanning electron microscope (SEM) image of the cross-section of the coil pattern 311 or 312 of the coil component 1000 in the length (L)-width (W) direction that is taken from its center in the thickness (T) direction. Here, the plurality of line segments may be equally spaced from each other, and the scope of the present disclosure is not limited thereto.

Referring to FIG. 2, the first and second coil portions 311 and 312 may include the first cut portions 311a and 312a, respectively, and the second cut portions 311b and 312b, respectively, sequentially disposed respectively in directions in which the outermost turns of the coil patterns 311 and 312 are wound from the outside to the inside. In detail, the first coil pattern 311 may include the first cut portion 311a and the second cut portion 311b sequentially disposed in the direction in which its outermost turn is wound from the outside to the inside. In addition, the second coil pattern 312 may include the first cut portion 312a and the second cut portion 312b sequentially disposed in the direction in which its outermost turn is wound from the outside to the inside.

In the first and second coil patterns 311 and 312 disposed on both the surfaces of the support member 200, respectively, the first cut portion 311a and 312a may be spaced apart from the first and second lead portions 331 and 332, respectively, and the second cut portion 311b and 312b may be adjacent to the lead portion 331 or 332, respectively. For example, referring to FIG. 2, in the second coil pattern 312 disposed on the upper surface of the support member 200, the first cut portion 312a may be spaced apart from the second lead portion 332, and the second cut portion 312b may be adjacent to the second lead portion 332. In addition, in the first coil pattern 311 disposed on the lower surface of the support member 200, the first cut portion 311a may be spaced apart from the first lead portion 331, and the second cut portion 311b may be adjacent to the first lead portion 331.

Referring to FIG. 2, the first cut portion 312a of the second coil pattern 312 may face the first surface 101 of the body 100, and the second cut portion 312b of the second coil pattern 312 may face the second surface 102 of the body 100. However, the present disclosure is not limited thereto.

Referring to FIGS. 1 through 3, the lead portions 331 and 332 may extend from the coil patterns 311 and 312 to at least one of the first surface 101 and second surface 102 of the body 100. In detail, the first lead portion 331 may be connected to an outer end of the first coil pattern 311 and extend to the first surface 101 of the body 100 to thus be connected to the first external electrode 400 described below. In addition, the second lead portion 332 may be connected to an outer end of the second coil pattern 312 and extend to the second surface 102 of the body 100 to thus be connected to the second external electrode 500 described below.

Referring to FIGS. 1 and 2, at least one of the lead portions 331 and 332 may be off-centered and disposed on one side of the body based on a center line CL passing through a center C of the coil pattern 311 or 312 while being parallel to the first or L direction. In detail, the lead portion 331 or 332 may be off-centered and disposed on one side of the body based on the center line CL of the coil pattern 311 or 312 that is perpendicular to the first surface 101 of body 100 in the second or W direction on a cross-section of the coil pattern 311 or 312 that is perpendicular to its coil axis. Here, the center line CL may be defined as an imaginary line passing through the center of the coil pattern 311 or 312 and parallel to the first or L direction, based on the L-W cross-section.

Through this structure in which the first or second lead portion 331 or 332 is off-centered and disposed on one side of the body based on the center line CL, the coil pattern 311 or 312 may be disposed more outward in a coil component of the same size when compared to a case where the lead portion 331 or 332 is disposed on the center line CL. As a result, the core 110 may have a larger cross-sectional area, thereby improving the inductance characteristic of the coil component 1000.

Referring to FIGS. 1 and 2, the lead portion 331 or 332 may not pass through the center line CL. In detail, each of the first and second lead portions 331 and 332 may be disposed closer to the fourth surface 104 of the body than to the third surface 103. Through this structure, it is possible to secure a region for the coil patterns 311 and 312 to expand outward in a region adjacent to each of the first surface 101 and the second surface 102 of the body 100.

Referring to FIGS. 1 and 2, a center of a surface where the lead portion 331 or 332 and the first surface 101 or second surface 102 of the body 100 are in contact with each other may be spaced apart from the center line CL. For example, referring to FIG. 2, the center of the surface where the second lead portion 332 and the second surface 102 of the body 100 are in contact with each other may be spaced apart from the center line CL by a predetermined gap G1 in the second or W direction, based on the L-W cross-section.

In addition, the lead portion 331 or 332 of this exemplary embodiment may be spaced apart from the center line CL in the second or W direction. That is, the center of the surface where the lead portion 331 or 332 is exposed to the body 100 may be spaced apart from the center line CL, while the outermost boundary line of the lead portion 331 or 332 is completely spaced from the center line CL. For example, referring to FIG. 2, the second lead portion 332 may be spaced apart from the center line CL by a predetermined gap G2 in the second or W direction, based on the L-W cross-section.

Referring to FIG. 2, the surface where the first or second lead portion 331 or 332 is in contact with the first surface 101 or second surface 102 of the body 100 may have a line width (a thickness in W direction) larger than a line width of a region where the lead portion 331 or 332 is connected to the coil pattern 311 or 312. For example, a line width Wo of the surface of the second lead portion 332 that is in contact with the second surface 102 of the body 100 may be larger than a line width Wi of the region where the second lead portion 332 is connected to the second coil pattern 312. In this exemplary embodiment, the line width may have a tapered shape by being gradually increased from a region where the second lead portion 332 is connected to the second coil pattern 312 to the region where the second lead portion 332 is in contact with the second surface 102 of the body 100. However, the present disclosure is not limited thereto.

Through the structure of the present embodiments, it is possible to increase a contact area between the first or second lead portion 331 and 332 and the external electrode 400 and 500, respectively, thereby reducing direct current (DC) resistance R_{dc} of the coil 300, and improving an adhesion strength of the lead portion with the external electrode 400 or 500.

Referring to FIG. 5, the coil 300 may further include the via 320 connecting the first and second coils patterns 311 and 312 to each other, respectively. In detail, the via 320 may pass through the support member 200 to thus connect inner ends of the innermost turns of the first and second coils patterns 311 and 312 to each other. Accordingly, a signal input to the first external electrode 400 may be output to the second external electrode 500 through the first lead portion 331, the first coil pattern 311, the via 320, the second coil pattern 312, and the second lead portion 332. Through this structure, the respective components of the coil 300 may function as one coil connected between the first and second external electrodes 400 and 500.

At least one of the coil patterns 311 and 312, the via 320, and the lead portions 331 and 332 may include at least one conductive layer.

For example, the first coil pattern 311, the via 320, and the first lead portion 331 may be plated on the lower surface of the support member 200 (based on the directions shown in FIG. 1). In this case, each of the first coil pattern 311, the via 320, and the first lead portion 331 may include a seed layer and an electroplating layer. The seed layer may be formed by a vapor deposition method such as electroless plating or sputtering. Each of the seed layer and the electroplating layer may have a single-layer structure or a multilayer structure. The electroplating layer having the multilayer structure may be a conformal film in which another electroplating layer covers one electroplating layer, or may be a layer in which another electroplating layer is laminated on only one surface of one electroplating layer. The seed layer of the first coil pattern 311, the seed layer of the via 320, and the seed layer of the first lead portion 331 may be integrally formed to thus have no boundary therebetween, but the present disclosure is not limited thereto. The electroplating layer of the first coil pattern 311, the electroplating layer of the via 320, and the electroplating layer of the first lead portion 331 may be integrally formed to thus have no boundary therebetween, but the present disclosure is not limited thereto.

Each of the coil patterns 311 and 312, the via 320, and the lead portions 331 and 332 may be formed of a conductive material such as copper (Cu), aluminum (Al), silver (Ag), tin (Sn), gold (Au), nickel (Ni), lead (Pb), titanium (Ti), chromium (Cr), molybdenum (Mo) or an alloy thereof, but the present disclosure is not limited thereto. Meanwhile, the cut portion 311a, 311b, 312a, or 312b may be patterned using a plating resist when the first or second coil pattern 311 or 312 is plated, but the present disclosure is not limited thereto, and may be formed by removing a predetermined region after forming the coil pattern 311 or 312.

The first and second external electrodes 400 and 500 may respectively be disposed on the first surface 101 and the second surface 102 of the body 100, and respectively connected to the first and second lead portions 331 and 332. In detail, the first external electrode 400 may be disposed on the first surface 101 of the body 100 and in contact with the first lead portion 331. In addition, the second external electrode 500 may be disposed on the second surface 102 of the body 100 and in contact with the second lead portion 332.

The external electrodes 400 and 500 may electrically connect the coil component 1000 to a printed circuit board or the like when the coil component 1000 according to this exemplary embodiment is mounted on the printed circuit board or the like. For example, each of the external electrodes 400 and 500 disposed on the first surface 101 and second surface 102 of the body 100 while being spaced apart from each other may be electrically connected to a connection part of the printed circuit board.

The external electrode 400 or 500 may be made of a conductive material such as copper (Cu), aluminum (Al), silver (Ag), tin (Sn), gold (Au), nickel (Ni), lead (Pb), chromium (Cr), titanium (Ti), or an alloy thereof, but the present disclosure is not limited thereto.

Each of the external electrodes 400 and 500 may include a plurality of layers. For example, the first external electrode 400 may include a first layer in contact with the first lead portion 331 and a second layer disposed on the first layer. Here, the first layer may be a conductive resin layer including conductive powders including at least one of copper (Cu) or silver (Ag) and insulating resin, or may be a copper (Cu) plating layer. The second layer may have a double layer structure of a nickel (Ni) plating layer and/or a tin (Sn) plating layer.

Referring to FIGS. 3 through 5, an insulating film IF may be disposed between the coil 300 and the body 100 to cover the coil 300. The insulating film IF may be formed along the surfaces of the support member 200 on which the first and second coils are not disposed and the coil 300 including the first and second coil patterns 311 and 312. The insulating film IF may be used for insulating the coil 300 from the body 100, and include a well-known insulating material such as parylene. However, the present disclosure is not limited thereto. The insulating film IF may be formed by the vapor deposition method or the like, but the present disclosure is not limited thereto, and may be formed by laminating insulating films on both the surfaces of the support member 200.

Meanwhile, the coil component 1000 according to this exemplary embodiment may further include an insulating layer disposed in a region other than the regions where the external electrodes 400 and 500 are disposed while covering the third to sixth surfaces 103, 104, 105, and 106 of the body 100.

The insulating layer may be formed, for example, by coating and curing an insulating material including the insulating resin on the surface of the body 100. In this case, the insulating layer may include at least one of thermoplastic resin such as polystyrene-based resin, vinyl acetate-based resin, polyester-based resin, polyethylene-based resin, polypropylene-based resin, polyamide-based resin, rubber-based resin, acrylic-based resin, thermosetting insulating resin such as phenol-based resin, epoxy-based resin, urethane-based resin, melamine-based resin, or alkyd-based resin, or the photosensitive insulating resin.

### Second Exemplary Embodiment

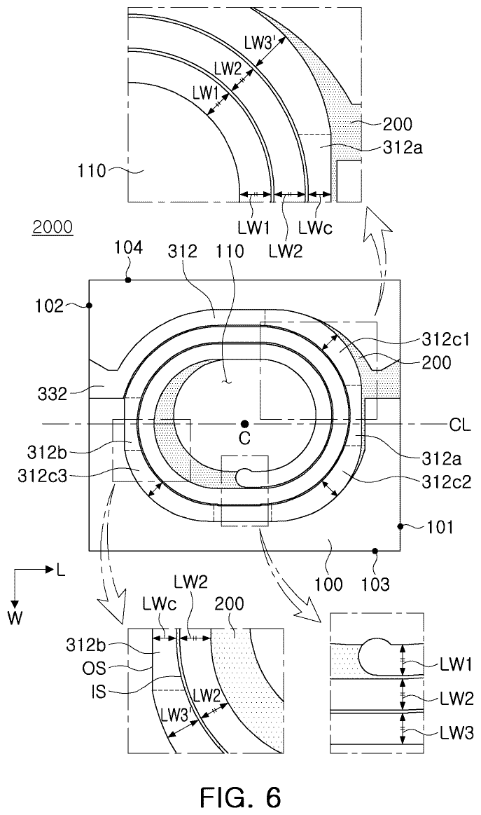

FIG. 6 is a partially enlarged view of a coil component 2000 according to a second exemplary embodiment of the present disclosure, illustrates an L-W cross-section of the coil component, and is a view corresponding to FIG. 2.

When comparing FIG. 6 with FIG. 2, this exemplary embodiment is different from a first exemplary embodiment in that the line width LWc of a corner portion 311c or 312c of the outermost turn of the coil pattern 311 or 312 is larger than a line width of the adjacent turn or adjacent region.

Therefore, in describing this exemplary embodiment, the corner portion 311c or 312c, which is different from the configuration in a first exemplary embodiment of the present disclosure, is only described, and the descriptions of the other components in a first exemplary embodiment of the present disclosure may be equally applied to descriptions of those in this exemplary embodiment.

Referring to FIG. 6, the outermost turn of the first coil pattern 311 may further include at least one corner portion 311c1, 311c2, or 311c3 whose maximum line width LW3′ is larger than the maximum line width of a turn adjacent thereto such as LW1 or LW2, or the second coil pattern 312 may further include at least one corner portion 312c1, 312c2, or 312c3 whose maximum line width LW3′ is larger than the maximum line width of a turn adjacent thereto such as LW1 or LW2. The corner portion 311c1, 311c2, 311c3, 312c1, 312c2, or 312c3 may be a component for offsetting R_{dc} characteristic deterioration (or R_{dc} increase) occurring due to the formation of the cut portion 311a, 311b, 312a, or 312b. That is, considering a dicing process, it is possible to lower the R_{dc} by making the corner portion 311c1, 311c2, 311c3, 312c1, 312c2, or 312c3 facing a corner region of the first or second coil pattern 311 or 312, which has a spatial margin compared to a region of the coil pattern that is adjacent to each surface of the body 100, have the larger line width.

Here, the maximum line width of the outermost turn of the coil pattern 311 or 312 may indicate, for example, the maximum value of the respective dimensions of the plurality of line segments spaced apart from each other and connecting the respective boundaries of the inner surface IS and outer surface OS of the coil pattern 311 or 312 shown in the following image, based on the optical microscope image or scanning electron microscope (SEM) image of the cross-section of the coil pattern 311 or 312 of the coil component 1000 in the length (L)-width (W) direction that is taken from its center in the thickness (T) direction. However, the scope of the present disclosure is not limited thereto.

Referring to FIG. 6, for convenience of explanation, the boundaries between the corner portion 311c1, 311c2, 311c3, 312c1, 312c2, or 312c3 of the outermost turn of the coil pattern 311 or 312 and its adjacent region are marked by dotted lines. However, the corner portion 311c1, 311c2, 311c3, 312c1, 312c2, or 312c3 may be integrally formed with the adjacent region, and no boundary may thus appear therebetween. In addition, the corner portion 311c1, 311c2, 311c3, 312c1, 312c2, or 312c3 of the outermost turn of the coil pattern 311 or 312 may indicate a region where at least one of the inner surface IS and the outer surface OS has the curvature larger than zero. However, the present disclosure is not limited thereto.

The outermost turn of the first coil pattern 311 may include at least one corner portion 311c1, 311c2 or 311c3 disposed in a region adjacent to a corner of the body 100, or the outermost turn of the second coil pattern 312 may include at least one corner portion 312c1, 312c2 or 312c3.

In detail, the corner portion 311c1, 311c2 and 311c3 may be disposed in a region spaced apart from the first lead portion 331 or the corner portion 312c1, 312c2 and 312c3 may be disposed in a region spaced apart from the second lead portion 332 among diagonal regions where the corners of the body 100 formed by the first to fourth surfaces 101, 102, 103, and 104 of the body 100 are connected to each other, on the cross-section of the first or second coil pattern 311 or 312 that is perpendicular to its coil axis. For example, referring to FIG. 6, the corner portion 312c1, 312c2, and 312c3 may be disposed in regions where the corner of the body 100 that is formed by the first surface 101 and the fourth surface 104, the corner of the body formed by the first surface 101 and the third surface 103 and the corner of the body that is formed by the second surface 102 and the third surface 103, respectively, based on the L-W cross-section.

Referring to FIG. 6, the corner portion 311c1, 311c2, 311c3, 312c1, 312c2, or 312c3 may include the inner surface IS and the outer surface OS opposing each other, and the inner surface IS and outer surface OS of the corner portion 311c1, 311c2, 311c3, 312c1, 312c2, or 312c3 may have the different curvatures. For example, the outer surface OS of the corner portion 311c1, 311c2, 311c3, 312c1, 312c2, or 312c3 may have the curvature larger than that of the inner surface IS, but the present disclosure is not limited thereto. That is, the outer surface OS and inner surface IS of the corner portion 311c1, 311c2, 311c3, 312c1, 312c2, or 312c3 may have substantially the same curvature. Here, being substantially the same indicates being the same, including the process error, a position deviation, or a measurement error that occurs in a manufacturing process.

Referring to FIG. 6, the corner portion 311c1, 311c2, 311c3, 312c1, 312c2, or 312c3 may have the maximum line width LW3′ in a region having a minimum distance between the corner of body 100 that is formed by one of the first to fourth surfaces 101, 102, 103, and 104 and the corner portion 311c1, 311c2, 311c3, 312c1, 312c2, or 312c3.

Here, the distance between the corner of the body 100 and the corner portion 311c1, 311c2, 311c3, 312c1, 312c2, or 312c3 may indicate, for example, the minimum value of respective dimensions of a plurality of line segments spaced apart from each other and connecting a tangent of the outer surface of the outermost turn of the coil pattern 311 or 312 with the corner of the body 100 shown in the following image, based on the optical microscope image or scanning electron microscope (SEM) image of the cross-section of the coil pattern 311 or 312 of the coil component 1000 in the length (L)-width (W) direction that is taken from its center in the thickness (T) direction. Alternatively, this distance on the image may be measured using a program of image J, but the present disclosure is not limited thereto.

The corner portions 311c1, 311c2, 311c3, 312c1, 312c2, and 312c3 may include the first to third corner portions 311c1, 311c2, 311c3, 312c1, 312c2, and 312c3 sequentially disposed in the directions in which the outermost turns of the first and second coil patterns 311 and 312 are wound from the outside, where closer to the body, to the inside, where closer to the core. In detail, the first coil pattern 311 may include the first to third corner portions 311c1, 311c2, and 311c3, sequentially disposed in the direction in which its outermost turn is wound from the outside to the inside. In detail, the second coil pattern 312 may include the first to third corner portions 312c1, 312c2, and 312c3, sequentially disposed in the direction in which its outermost turn is wound from the outside to the inside.

The coil component 2000 according to this exemplary embodiment may include the corner portion 311c1, 311c2, 311c3, 312c1, 312c2, and 312c3 of the outermost turn of the first or second coil pattern 311 or 312, and each of the corner portion 311c1, 311c2, 311c3, 312c1, 312c2, and 312c3 may have the large line width LW3′ to thus lower the R_{dc}, thereby offsetting the R_{dc} characteristic deterioration (or R_{dc} increase) occurring due to the formation of the cut portion 311a, 311b, 312a, or 312b.

### Third Exemplary Embodiment

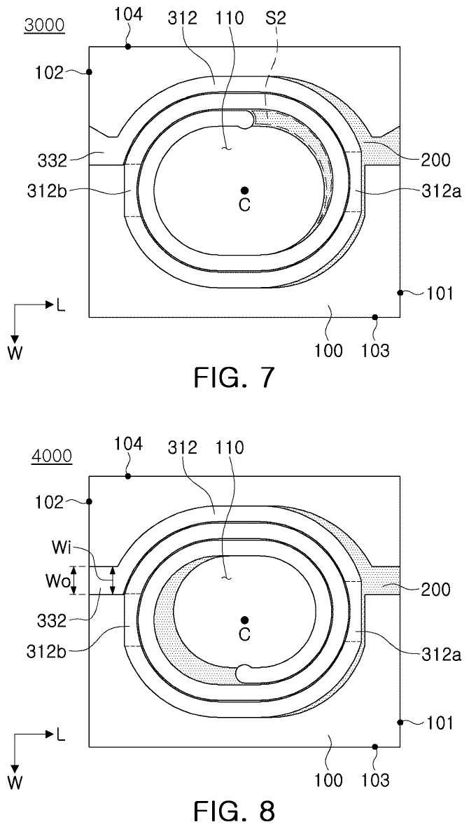

FIG. 7 is a view schematically illustrating an L-W cross-section of a coil component 3000 according to a third exemplary embodiment of the present disclosure, and is a view corresponding to FIG. 2.

When comparing FIG. 7 with FIG. 2, this exemplary embodiment is different from a first exemplary embodiment in the number of turns of the first and second coil pattern 311 or 312, the disposition of the via 320, and an area S2 of a remaining area in the support member 200.

Therefore, in describing this exemplary embodiments, the number of turns of the first and second coil pattern 311 or 312, the disposition of the via 320, and the area S2 of the remaining area in the support member 200, which are different from those in a first exemplary embodiment of the present disclosure, are only described, and the descriptions of the other components in a first exemplary embodiment in the present disclosure may be equally applied to descriptions of those in this exemplary embodiment.

Referring to FIG. 7, in the coil component 3000 according to this exemplary embodiment, a natural number value may be an even value when taken from sum of a total number of turns of the first and second coil patterns 311 and 312. That is, the sum of the total number of turns of the first and second coil patterns 311 and 312 may be expressed as a value of 2n+0.1x (wherein n is a positive integer of 1 or more). Here, the number of turns may be defined as the number of turns from the outermost end of the outermost turn to the inner end of the innermost turn of each coil pattern 311, 312.

When comparing FIGS. 2 and 7 with each other, in a first exemplary embodiment (shown in FIG. 2), the total number of turns of the first and second coil patterns 311 and 312 may be approximately 5.4 turns (=2.7 turns+2.7 turns) when the via 320 is disposed in a lower side, the second coil pattern 312 has approximately 2.7 turns, and the first coil pattern 311 has the same number of turns. In this case, the natural number value acquired by summing the number of turns may be an odd value. Here, more regions may exist where the first and second coil patterns 311 and 312 do not overlap each other, which results in a larger remaining area S1 in the support member 200 around the core 110.

On the other hand, in a third exemplary embodiment(shown in FIG. 7), the total number of turns may be approximately 4.4 turns (=2.2 turns+2.2 turns) when the via 320 is disposed in the lower side, the second coil pattern 312 has approximately 2.2 turns, and the first coil pattern 311 has the same number of turns. In this case, the natural number value acquired by summing the total number of turns may be the even value. Here, a fewer regions may exist where the first and second coil patterns 311 and 312 do not overlap each other, which results in the smaller remaining area S2 in the support member 200 around the core 110, thereby securing a larger effective volume.

### Fourth Exemplary Embodiment

FIG. 8 is a view schematically illustrating an L-W cross-section of a coil component 4000 according to a fourth exemplary embodiment of the present disclosure, and is a view corresponding to FIG. 2.

When comparing FIG. 8 with FIG. 2, this exemplary embodiment is different from a first exemplary embodiment in a shape of the first and second lead portion 331 and 332 and the width Wo of a lead surface (i.e., a thickness of the first or second lead portion in a W-L direction), that is, the surface of the lead portion that is in contact with the surface of the body.

Therefore, in describing this exemplary embodiment, the shape of at least one of the first or second lead portion 331 or 332 and the width Wo of the lead surface, which is different from one in the first exemplary embodiment of the present disclosure, is only described, and the descriptions of the other components in the first exemplary embodiment of the present disclosure may be equally applied to descriptions of those in this exemplary embodiment.

Referring to FIG. 8, in the coil component 4000 according to this exemplary embodiment, at least one of the first or second lead portion 331 or 332 may have a line width constant from a point where the first or second lead portion 331 or 332 is connected to the coil pattern 311 or 312, respectively, to a point where the first or second lead portion 331 or 332 is in contact with the first surface 101 or second surface 102 of the body 100, respectively. For example, the line width Wo of the surface of the second lead portion 332 that is in contact with the second surface 102 of the body 100 may be substantially the same as the line width Wi of the region where the second lead portion 332 is connected to the second coil pattern 312. Here, being substantially the same indicates being the same, including the process error, the position deviation, or the measurement error that occurs in the manufacturing process.

Through this structure, it is possible to reduce the volume of the lead portion 331 or 332 in the coil component of the same size to thus increase the effective volume in which the magnetic material may be disposed, thereby improving the inductance characteristic.

As set forth above, according to some embodiments of the present disclosure, it is possible to provide the coil component with the improved Isat characteristic in which the central core of the coil has the larger area to thus facilitate the flow of the magnetic flux.

According to some embodiments of the present disclosure, it is possible to provide the coil component with the improved Isat characteristic while minimizing the side effect in which the Rac is increased due to the reduced cross-sectional area of the lead portion.

While the exemplary embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface opposing each other in a first direction, and a third surface and a fourth surface opposing each other in a second direction, perpendicular to the first direction;
a support member disposed in the body;
a coil disposed on the support member, and including a coil pattern having at least one turn and a lead portion extending from the coil pattern to at least one of the first surface or second surface of the body; and
an external electrode disposed on the body and connected to the lead portion,
wherein a partial region of an outermost turn of the coil pattern has a line width in the second direction smaller than a line width in the second direction of remaining region, and
the lead portion is off-centered and disposed on one side of the body based on a center line passing through a center of the coil pattern which is parallel to the first direction.

2. The coil component of claim 1, wherein the lead portion does not pass through the center line.

3. The coil component of claim 1, wherein a center of a surface where the lead portion and the first surface or second surface of the body are in contact with each other is spaced apart from the center line.

4. The coil component of claim 3, wherein the lead portion is spaced apart from the center line in the second direction.

5. The coil component of claim 1, wherein a surface where the lead portion is in contact with the first surface or second surface of the body has a line width in the second direction larger than a line width in the second direction of a region where the lead portion and the coil pattern are connected to each other.

6. The coil component of claim 1, wherein the lead portion has a constant line width from a point where the lead portion is connected to the coil pattern to a point where the lead portion is in contact with the first surface or second surface of the body.

7. The coil component of claim 1, wherein the outermost turn of the coil pattern includes a cut portion having the line width in the second direction smaller than the line width of the remaining region, and
the cut portion has an inner surface and an outer surface opposing each other, and the inner surface has a curvature different from a curvature of the outer surface.

8. The coil component of claim 7, wherein the outer surface of the cut portion has the curvature smaller than a curvature of the inner surface.

9. The coil component of claim 8, wherein the outer surface of the cut portion is flat.

10. The coil component of claim 9, wherein the cut portion has an average line width in the second direction smaller than an average line width in the second direction of a turn adjacent to the cut portion.

11. The coil component of claim 7, wherein the outermost turn of the coil pattern includes first and second cut portions sequentially disposed in a direction in which the outermost turn of the coil pattern is wound from the outside to the inside, and
the first cut portion is disposed in a region spaced apart from the lead portion, and the second cut portion is disposed in a region adjacent to the lead portion.

12. The coil component of claim 1, wherein the outermost turn of the coil pattern further includes at least one corner portion disposed in a region adjacent to a corner of the body, and
a maximum line width of the corner portion in the second direction is larger than a maximum line width of a turn adjacent to the corner portion in the second direction.

13. The coil component of claim 12, wherein the corner portion includes an inner surface and an outer surface opposing each other, and
the inner surface of the corner portion has a curvature different from a curvature of the outer surface.

14. The coil component of claim 13, wherein the outer surface of the corner portion has the curvature larger than that of the inner surface.

15. The coil component of claim 12, wherein the corner portion has the maximum line width in a region having a minimum distance between the corner of the body and the corner portion.

16. The coil component of claim 1, wherein the coil further includes a first coil pattern disposed on one surface of the support member, a second coil pattern disposed on an opposite surface of the support member, and a via connecting the first and second coil patterns to each other, and
an even number is acquired when only a natural number is taken from sum of a total number of turns of the first and second coil patterns.
